(19) United States
(12) Patent Application Publication
(10) Pub. No.: US 2013/0148509 A1
(43) Pub. Date: Jun. 13, 2013

(54) NETWORK DEVICE WITH AUDIO-ALERT NOTIFICATION CAPABILITY

(71) Applicant: Aidan N. Low, Seattle, WA (US)

(72) Inventor: Aidan N. Low, Seattle, WA (US)

(21) Appl. No.: 13/316,235

(22) Filed: Dec. 9, 2011

(51) Int. Cl. G08B 3/10; H04L 12/26

(52) U.S. Cl. 370/242

(57) ABSTRACT

Methods and apparatus for outputting an audio indication in response to a temporary alteration in an Internet connection in an effort to more effectively notify users of the current connection situation are provided. In this manner, users are more likely to be notified of the temporary alteration in Internet connectivity, thereby potentially avoiding any adverse effects caused by such alteration, especially in applications that rely on constant Internet connectivity. These applications may include security surveillance, medical monitoring, and the like.

### TECHNICAL FIELD

Embodiments of the present disclosure generally relate to network communications and, more particularly, to audible notifications of temporary alterations in Internet connectivity.

### BACKGROUND

The Internet is a form of communication that has been embraced by the vast majority of individuals around the world. While initially begun as a form of communication between digital devices for the government, the Internet has quickly been embraced by the public, businesses, healthcare departments, and government networks on a local and global scale. As more of these individuals become further dependent on the Internet, Internet-based services become increasingly critical, and reliance on a stable Internet connection becomes ever more important, especially in fields such as security surveillance and medical monitoring.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example Internet connection between the Internet, a router, and an Internet-capable device in a local area network (LAN), in accordance with an embodiment of the present disclosure.

FIG. 2 illustrates an example router with sound-emitting capabilities, in accordance with an embodiment of the present disclosure.

FIG. 3 illustrates an example scenario where the Internet connection has been altered and the router has emitted a notification sound in response to the alteration in the Internet connection, in accordance with an embodiment of the present disclosure.

FIG. 4 is a flow diagram of example operations for emitting a notification sound in response to an Internet disconnection, in accordance with an embodiment of the present disclosure.

FIG. 5 is a flow diagram of example operations for emitting a notification sound in response to an Internet disconnection and a subsequent restoration of the Internet connection, in accordance with an embodiment of the present disclosure.

FIG. 6 is a flow diagram of example operations for outputting an audio indication upon determining that a network connection has been interrupted, in accordance with an embodiment of the present disclosure.

### DESCRIPTION OF EXAMPLE EMBODIMENTS

### Overview

Embodiments of the present disclosure generally relate to methods and apparatus for notification of an alteration in network connectivity (e.g., a disconnection or, in some cases, a reconnection to networks, such as the Internet) through sound emissions.

One embodiment of the present disclosure provides a method of audibly signaling a connectivity status of a network device. The method generally includes establishing, via the network device, a connection between a network and a network-capable device, the network device being configured to bidirectionally manage a flow of packets; determining that the connection with the network has been at least temporarily interrupted; and outputting, by the network device, a first audio indication based on the determination, the first audio indication being configured to audibly signal the interrupted connection.

Another embodiment of the present disclosure provides an apparatus. The apparatus generally includes at least one interface, at least one processor, and a speaker. The at least one interface is typically configured to receive traffic from a network via a connection. The at least one processor is typically configured to receive the traffic via the at least one interface and to determine that the connection with the network has been at least temporarily interrupted. The speaker is generally configured to receive a signal from the at least one processor for outputting a first audio indication based on the determination, the first audio indication being configured to audibly signal the interrupted connection.

Yet another embodiment of the present disclosure provides an apparatus. The apparatus generally includes means for establishing a connection between a network and a network-capable device, the apparatus being configured to bidirectionally manage a flow of packets; means for determining that the connection with the network has been at least temporarily interrupted; and means for outputting a first audio indication based on the determination, the first audio indication being configured to audibly signal the interrupted connection.

### Example Embodiments

Embodiments of the present disclosure provide methods and apparatus for indicating a change in Internet connectivity with at least one type of audible emission. According to some embodiments, a device capable of emitting tones, melodies, or other sounds may be implemented in the hardware of a router, a network hub, a switch or other network device and may emit an audio indication to indicate that the connection with the Internet has been altered including, but not limited to, disconnection and reconnection. In this manner, the user may be better aware of the condition of the Internet connection and, therefore, may be more capable of responding to disconnections from the Internet in a timely fashion, especially in applications that rely on constant Internet connectivity.

However, the problem with current Internet connection devices, such as routers, is that these devices only notify users of their disconnection with the Internet through a blinking light on the actual device or a pop-up icon on the bottom or top right hand corner of a computer screen. These notification methods can be easily overlooked. Also, these notification methods are not useful for visually impaired users. When the Internet is relied on for important operations, these notification methods insufficiently capture the user's attention and increase the likelihood of causing users to be completely unaware of the temporary altered Internet connection.

Although embodiments of the present disclosure are generally described with respect to Internet connectivity, it should be noted that connectivity with any type of network may be involved for certain embodiments.

### An Example Internet Connection

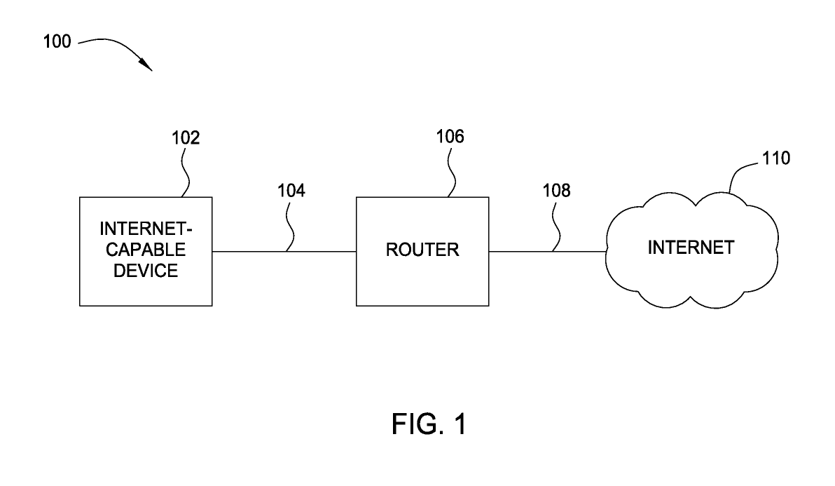

FIG. 1 illustrates an example Internet connection 100 utilizing a network device, such as router 106, to connect a network-capable device (e.g., an Internet-capable device 102) to the Internet 110 or other network via connections 104 and 108. For example, the network device may be at least one of a wireless or wired router, a wired Ethernet network hub, or a wireless hotspot device capable of connecting to the Internet. For some embodiments, a modem (not shown), such as a cable or Digital Subscriber Line (DSL) modem, may be connected between the network device and the Internet to provide Internet access, while for other embodiments, the network device may include the modem. Connections 104 and 108 may include wired or wireless connections capable of transmitting data and/or control information, typically in the form of packets, between the Internet 110 and the Internet-capable device 102. The Internet-capable device 102 may consist of any device including, but not limited to, a personal computer (PC), a security system, a tablet, a smart phone, or a medical monitoring device that relies on a stable, uninterrupted Internet connection.

An example stable, uninterrupted Internet connection may entail the ability to transfer packets from the Internet 110 to the router 106 (and vice versa) through a wired or wireless connection 108 in addition to the ability to transfer packets from the router 106 to an Internet-capable device 102 (and vice versa) through a wired or wireless connection 104. A wired connection may consist of Cat5 Ethernet cable or any other suitable connection link capable of transmitting packets from a source to a receiver. A wireless connection may include any suitable wireless channel capable of supporting a communication link between two or more devices wirelessly.

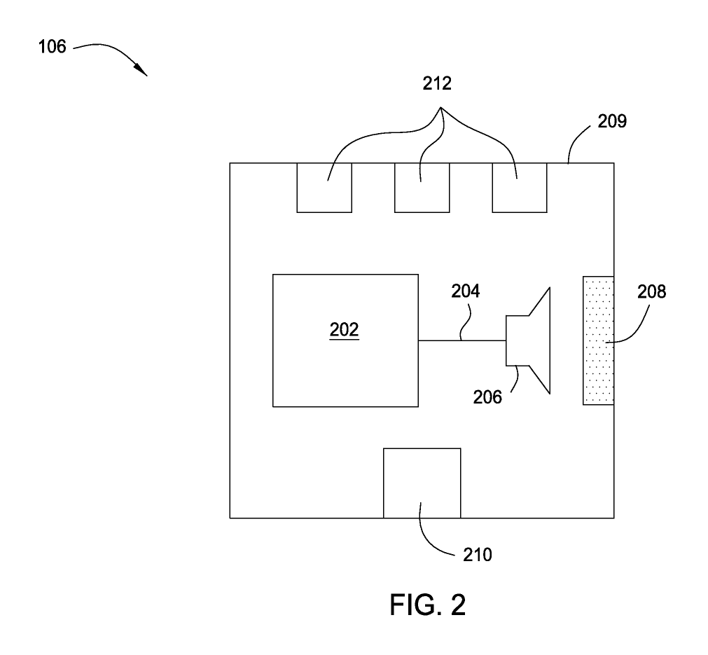

According to one embodiment illustrated in FIG. 2, a router 106 may incorporate a sound-emitting device 206. The router 106 may include one or more suitable interfaces (e.g., ports, antennas, and the like) for connection with the network, such as input port 210 and one or more output ports 212. The input port 210 may be connected with the Internet 110, while one of the output ports 212 may be connected with the Internet-capable device 102. The router 106 may include at least one processor 202 or sound controller to determine whether the Internet connection has been altered (e.g., disconnected or otherwise interrupted) and to subsequently control the tone and composition of outputted sound according to the respective alteration in Internet connectivity. The processor 202 may output electrical signals to a sound emitter 206 via a connection 204, such that the sound emitter 206 may emit audio signals based on the received electrical signals. Accordingly, the sound emitter 206 may include any of various suitable sound-emitting devices, such as a speaker or any suitable device capable of converting an electrical signal into an audible tone.

A perforated section 208 in the router housing 208 may be utilized to allow sound waves to travel from the emitter 206 through the housing and into the ambient environment. The perforated section 208 may also protect the sound emitter 206. For some embodiments, the perforated section may be replaced with a hard or a soft speaker grille or cover, which may include a screen or a mesh. The speaker grille or cover may include cloth, plastic, metal, foam, or any other suitable material.

### An Example Internet Interruption with a Network Device Capable of Emitting Sound

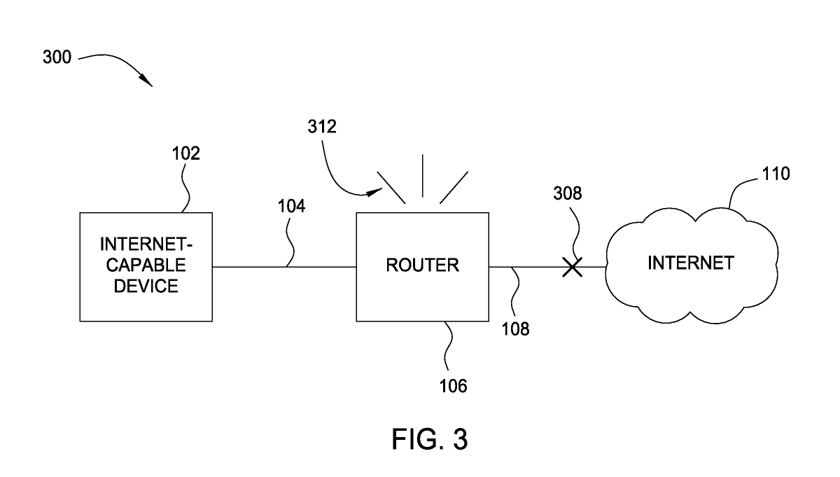

FIG. 3 illustrates an example scenario 300 where an audible sound is emitted if the Internet connection has been, at least temporarily, altered. The local area network (LAN) of FIG. 1 may operate with a stable connection 104 between the Internet-capable device 102 and a router 106 with audio-emitting capabilities. The connection 108 between the Internet 110 and the router 106 may be temporarily altered (e.g., disconnected) as represented by disconnection 308. As a result of the disconnection 308, the router 106 may emit an audio indication 312 indicating its current altered status, which may alert the user that the Internet connection has been lost and may prompt the user to respond accordingly. It should be noted that alterations in Internet connections are not limited to only communication between the Internet 110 and the router 106. Change in the connection between any devices in FIGS. 1 and 3 may constitute an alteration of Internet connectivity. For example, a disconnection or reconnection between the Internet 110 and the router 106 or a disconnection or reconnection between the Internet-capable device 102 and the router 106 may constitute an alteration of Internet connectivity.

The audio indication 312 may be configured to emit a variety of sound patterns. For example, the audio indication may include one short “beep” to indicate a temporary alteration in the Internet connection, such as a disconnection. In another example, the audio indication 312 may include a constant repetition of short “beeps” separated by silent intervals indicating that the Internet connection is still in an altered Internet connection state, thereby periodically, or at least persistently, notifying the user of the altered status. The audio indication may cease when the Internet connection has been restored (i.e., reconnected). For some embodiments, the audio indication 312 may be configured to emit music or voice, whether synthesized or a recording. For example, the audio indication may include a short phrase, such as “Internet has been disconnected.” In essence, any audible composition may be used to notify the user of the altered Internet connectivity.

Altered connection status may also include reconnection in addition to disconnection. Accordingly, the sound emitter 206 may emit an audible notification indicating a reconnection with the Internet. Thus, subsequent to a disconnection, the audio indication 312 may include three short “beeps” (i.e., tones having a duration in a range of about 40 ms to 400 ms) or one long tone (i.e., a tone having a duration of at least 400 ms), for example, to indicate reconnection of the router 106 to the Internet 110.

In one embodiment, the audio indication 312 may include a varying tone that may change in frequency or pitch according to the length of time the Internet connection has been in its altered state. For example, the audio indication may include repetitive short “beeps” where the initial period between the beeps is relatively long (or short), but where the period is reduced (or increased) the longer the Internet connection remains in the altered connection state. For example, the period may be reduced (or increased) after every five minutes the Internet connection remains in its altered connection state. In another example, the audio indication may initially be emitted as a tone with a relatively low (or high) pitch (frequency), but the pitch may be increased (or decreased) the longer the Internet connection remains in the altered connection state. For example, the pitch may be increased (or decreased) after every minute the Internet connection remains in its altered connection state.

In another embodiment, the router 106 may emit an audio indication 312 according to a user profile. For example, the first user may have an audio profile composed of a three-tone chime, while a second user may have a different audio profile, such as a five-tone chime emitted as the audio indication 312 when the respective user's Internet connection is altered.

In another embodiment, the audio indication 312 may emit a sound when the Internet is connected, instead of emitting a sound when the Internet is not connected. For example, an intermittent or periodic “beep” may continually notify the user that the Internet connection remains viable. However, once the Internet connection is altered, in this case disconnected, the intermittent “beep” may cease, notifying the user that the Internet connection is in an altered connection state.

In another embodiment, when multiple routers are present, each router may have its own distinct audio profile sound emission when an alteration of Internet connectivity has occurred to distinguish each router from the others. For example, one router may have an audio indication 312 composed of a three-tone chime and another router may have an audio indication 312 composed of a five-tone chime. When the Internet connection of one router is altered, this router may emit its respective tone or other audio indication, notifying the user which router is in an altered Internet connection state.

In yet another embodiment, the router 106 may be able to distinguish which connection, 106 or 108, is altered and emit an audio notification respectively. For example, if the connection between the Internet 110 and the router 106 is altered, a three-tone chime may be emitted. However, if the connection between the router 106 and the Internet-capable device 102 is altered, a five-tone chime may be emitted. The distinction in audio indications may notify the user which connection needs to be repaired.

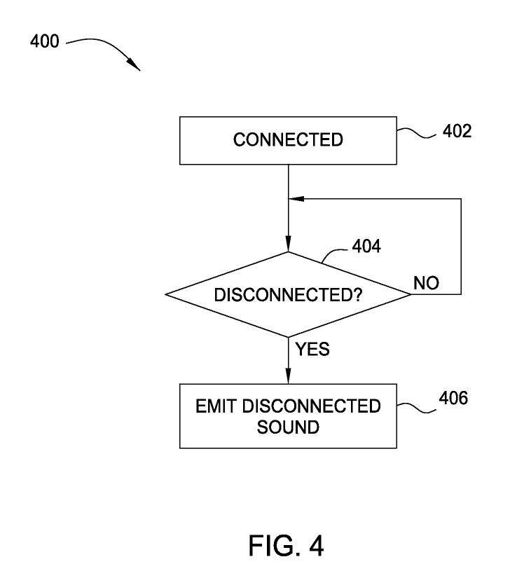

FIG. 4 is a flow diagram of example operations 400 for emitting sound from a network device with sound-emitting capabilities when a (temporary) disconnection in the Internet connection has occurred. The operations 400 may be performed by any suitable network device, such as a router 106 with a sound emitter 206. Thus, the operations 400 may be understood with reference to FIG. 3 which illustrates various situations where the router may emit sound to alert users of the alteration in Internet connectivity.

The operations 400 may begin, at 402, in a connected state with an operational Internet connection between the Internet 110 and an Internet-capable device 102 via the network device. At 404, the network device may detect a temporary alteration in the Internet connection. For example, the network device may determine whether the Internet connection has been, at least temporarily, disconnected. At 406, the network device may emit a sound representing a disconnection from the Internet, such as a short “beep,” a continuous tone, or a constant series of short “beeps” separated by intervals of silence. If the network device does not detect a disconnection at 404, the network device may continue to monitor the connection with the Internet.

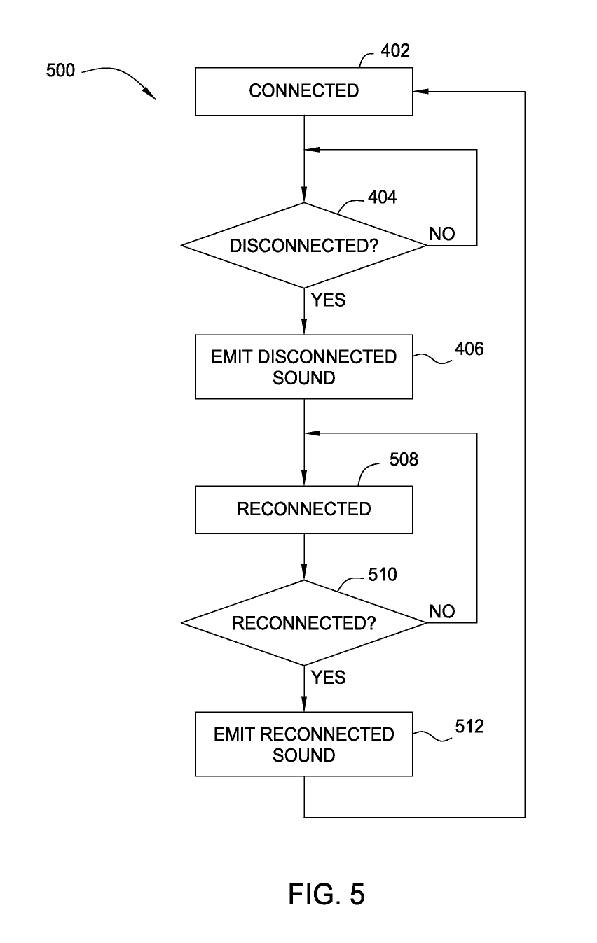

FIG. 5 is a flow diagram of example operations 500 for emitting sound from a network device with sound-emitting capabilities when a temporary disconnection in the Internet connection has occurred followed by a reconnection. The operations 500 may be performed by any suitable network device, such as a router 106 with a sound emitter 206. Thus, the operations 500 may be understood with reference to FIG. 3 which illustrates various situations where the router may emit sound to alert users of the alteration in Internet connectivity.

The operations 500 may begin, at 402, in a connected state with an operational Internet connection between the Internet 110 and an Internet-capable device 102 via the network device. At 404, the network device may determine whether the Internet connection has been, at least temporarily, disconnected. At 406, the network device may emit a sound representing a disconnection from the Internet. If the network device does not detect a disconnection at 404, the network device may continue to monitor the connection with the Internet.

Once a disconnection with the Internet has occurred, the network device may attempt to reconnect to the Internet at 508. This may occur automatically, or in some cases, a user may take action to restore the Internet connection. If the Internet connection has been restored as established at 510, the network device may emit a sound indicating such change in its connection status at 512 and return to the connected state at 402. Since the connection state has returned to its beginning state, operations 500 may then operate like a closed-loop system.

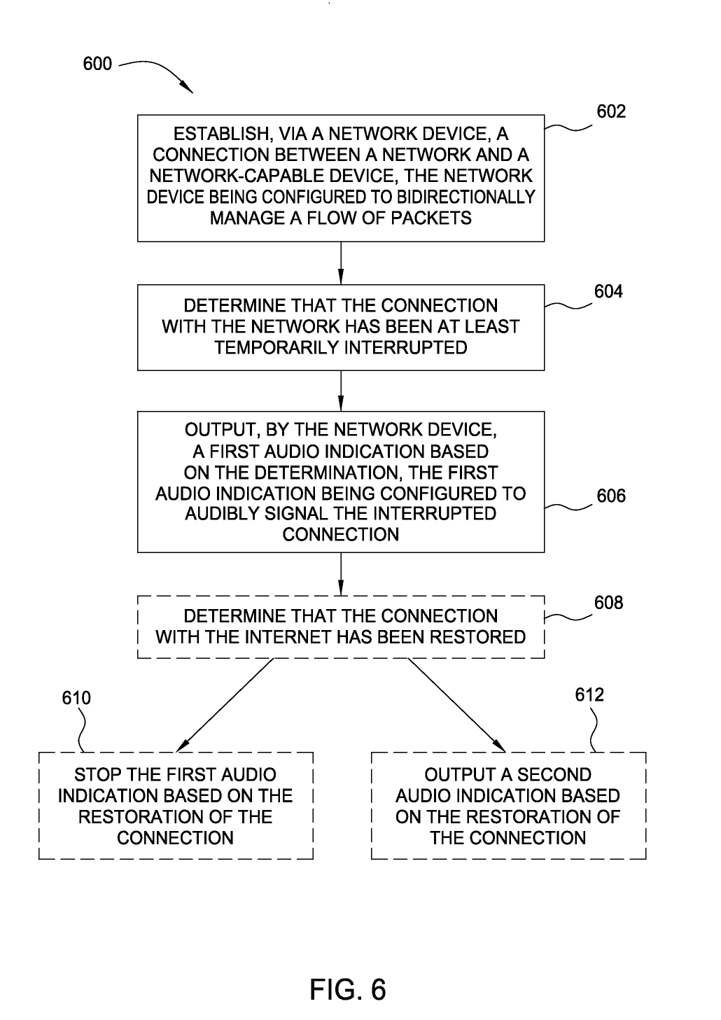

FIG. 6 is a flow diagram of example operations 600 for outputting an audio indication upon determining that a network connection has been interrupted (e.g., has been disconnected). The operations 600 may be performed by a network device, such as a router with a sound emitter 206. Thus, the operations 600 may be understood with reference to FIG. 3 which illustrates various situations where the router may emit sound to alert users of the alteration in Internet connectivity.

The operations 600 may begin, at 602, by establishing, via the network device, a connection between a network (e.g., the Internet) and a network-capable device. The network device may be configured to bidirectionally manage a flow of packets. At 604, the network device may determine that the connection with the network has been at least temporarily interrupted.

At 606, the network device may then output a first audio indication based on the determination. The first audio indication is configured to audibly signal the interrupted connection. The first audio indication may include a single tone or a sequence of tones (e.g., three short bursts), which may be long, short, or a combination thereof. For some embodiments, the first audio indication may include a periodic beeping tone or a continuous tone (i.e., a single long tone). For other embodiments, the first audio indication may include a melody (such as, or similar to, a ring tone) of one or more frequencies, typically in the audible range from about 15 Hz to 20 kHz. For some embodiments, the first audio indication may comprise a Morse code message to indicate the interrupted connection.

According to some embodiments, the network device may continue to output the first audio indication until the network connection is restored. For other embodiments, the first audio indication may only continue for a certain amount of time. In such cases where the first audio indication has been discontinued, the first audio indication may be repeated one or more times after waiting a delay period.

For some embodiments, the network device may determine that the connection with the network has been restored at 608. For such embodiments, the network device may stop the first audio indication based on the restoration of the connection at 610. For other such embodiments, the network device may output a second audio indication based on the restoration of the connection at 612.

The second audio indication may most likely be different than the first audio indication. In this manner, an operator may determine that the Internet connection has been disconnected or restored solely based on the first and second audio indications, without having to look at a display or other visual indication on the network-capable device or the network device.

While the foregoing is directed to embodiments of the present disclosure, other and further embodiments of the disclosure may be devised without departing from the basic scope thereof, and the scope thereof is determined by the claims that follow.

What is claimed is:

1. A method comprising:
establishing, via a network device, a connection between a network and a network-capable device, the network device being configured to bidirectionally manage a flow of packets;
determining that the connection with the network has been at least temporarily interrupted; and
outputting, by the network device, a first audio indication based on the determination, the first audio indication being configured to audibly signal the interrupted connection.

2. The method of claim 1, wherein the outputting comprises emitting the first audio indication from a speaker associated with the network device.

3. The method of claim 1, wherein the network comprises the Internet and wherein the network device comprises a router.

4. The method of claim 1, wherein the first audio indication comprises one of a periodic beeping tone and a continuous tone.

5. The method of claim 1, further comprising:
determining that the connection with the network has been restored; and
stopping the first audio indication based on the restoration of the connection.

6. The method of claim 1, further comprising:
determining that the connection with the network has been restored; and
outputting a second audio indication based on the restoration of the connection.

7. The method of claim 6, wherein the second audio indication is different than the first audio indication.

8. The method of claim 7, wherein the second audio indication comprises a single tone having a duration of at least 400 ms.

9. An apparatus comprising:
at least one interface configured to receive traffic from a network via a connection;
at least one processor configured to:
receive the traffic via the at least one interface; and
determine that the connection with the network has been at least temporarily interrupted; and
a speaker configured to receive a signal from the at least one processor for outputting a first audio indication based on the determination, the first audio indication being configured to audibly signal the interrupted connection.

10. The apparatus of claim 9, wherein the network comprises the Internet and wherein the apparatus comprises a router.

11. The apparatus of claim 9, wherein the first audio indication comprises one of a single tone, a sequence of tones, a melody, and a voice.

12. The apparatus of claim 9, wherein the at least one processor is configured to:
determine that the connection with the network has been restored; and
stop the speaker from outputting the first audio indication based on the restoration of the connection.

13. The apparatus of claim 9, wherein the at least one processor is configured to determine that the connection with the network has been restored and wherein the speaker is configured to output a second audio indication based on the restoration of the connection.

14. The apparatus of claim 13, wherein the second audio indication is different than the first audio indication.

15. An apparatus comprising:
means for establishing a connection between a network and a network-capable device, the apparatus being configured to bidirectionally manage a flow packets:
means for determining that the connection with the network has been at least temporarily interrupted; and
means for outputting a first audio indication based on the determination, the first audio indication being configured to audibly signal the interrupted connection.

16. The apparatus of claim 15, wherein the network comprises the Internet and wherein the apparatus comprises a router.

17. The apparatus of claim 15, wherein the first audio indication comprises a periodic beeping tone or a continuous tone.

18. The apparatus of claim 15, further comprising:
means for determining that the connection with the network has been restored; and
means for stopping the first audio indication based on the restoration of the connection.

19. The apparatus of claim 15, further comprising:
means for determining that the connection with the network has been restored; and
means for outputting a second audio indication based on the restoration of the connection.

20. The apparatus of claim 19, wherein the second audio indication is different than the first audio indication.
